(19) United States
(12) Patent Application Publication
(10) Pub. No.: US 2024/0187930 A1
(43) Pub. Date: Jun. 6, 2024

(54) COORDINATING UPSTREAM AND DOWNSTREAM TRAFFIC BETWEEN ACCESS POINTS

(71) Applicant: Cisco Technology, Inc., San Jose, CA (US)

(72) Inventors: John M. SWARTZ, Lithia, FL (US); Robert E. BARTON, Richmond (CA); Jerome HENRY, Pittsboro, NC (US); Matthew A. SILVERMAN, Shaker Heights, OH (US); Fred J. ANDERSON, Lakeville, OH (US)

(21) Appl. No.: 18/060,843

(22) Filed: Dec. 1, 2022

(51) Int. Cl. H04W 28/08; H04W 48/20; H04W 72/12

(52) U.S. Cl. CPC H04W 28/0942; H04W 28/0808; H04W 48/20; H04W 72/1257

(57) ABSTRACT

A method includes monitoring an upstream traffic demand at a first access point and based at least in part on the upstream traffic demand on the first access point, communicating a message that causes a mobile device to transmit upstream messages to the first access point and to receive downstream messages from a second access point. The first access point is physically closer to the mobile device than the second access point.

### TECHNICAL FIELD

Embodiments presented in this disclosure generally relate to wireless communications. More specifically, embodiments disclosed herein relate to the coordination of upstream and downstream traffic between wireless access points.

### BACKGROUND

Network deployments with many access points may be installed at large public venues (e.g., theaters, stadiums, and arenas). When guests or spectators are at a venue, their mobile devices may connect to the Internet or another network through the access points deployed at the venue.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example access point in the system of FIG. 1.

FIG. 3 illustrates an example controller in the system of FIG. 1.

FIG. 4 illustrates an example of access point switching in the system of FIG. 1.

FIG. 5 is a flowchart of an example method performed in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, a method includes monitoring an upstream traffic demand at a first access point and based at least in part on the upstream traffic demand on the first access point, communicating a message that causes a mobile device to transmit upstream messages to the first access point and to receive downstream messages from a second access point. The first access point is physically closer to the mobile device than the second access point.

According to another embodiment, an apparatus includes a memory and a processor communicatively coupled to the memory. The processor monitors an upstream traffic demand at a first access point and based at least in part on the upstream traffic demand on the first access point, communicates a message that causes a mobile device to transmit upstream messages to the first access point and to receive downstream messages from a second access point. The first access point is physically closer to the mobile device than the second access point.

According to another embodiment, a non-transitory computer readable medium stores instructions that, when executed by a processor, cause the processor to determine an upstream traffic demand at a first access point positioned a first distance from a mobile device and compare the upstream traffic demand to a threshold. In response to determining that the upstream traffic demand exceeds the threshold, the processor communicates a message that causes the mobile device to transmit upstream messages to the first access point and to receive downstream messages from a second access point positioned a second distance from the mobile device. The first distance is shorter than the second distance.

### Example Embodiments

Network deployments with many access points may be installed at large public venues (e.g., theaters, stadiums, and arenas). When guests or spectators are at a venue, their mobile devices may connect to the Internet or another network through the access points deployed at the venue. Typically, a mobile device will connect to the access point that is physically closest to the mobile device. The mobile device will then send upstream traffic and receive downstream traffic from that access point.

Large venues also have experienced an increase in livestreaming. For example, guests or spectators often use their mobile devices to livestream or livecast events occurring at a venue to the Internet. As a result, the amount of upstream traffic received at the access points from the mobile devices is increasing, which degrades network performance. For example, it has been observed that access points positioned within the same area tend to receive large amounts of upstream traffic from mobile devices around the same time as guests or spectators in that area all begin to livestream or livecast the same event occurring in that area. These access points quickly run out of capacity to handle other types of network traffic (e.g., downstream traffic to the mobile devices in the area). As a result, the mobile devices in that area experience difficulty receiving downstream traffic and sending upstream traffic.

The present disclosure contemplates a system that coordinates the upstream and downstream traffic in a network deployment. Specifically, the system includes a controller that determines an aggregate upstream traffic demand for the access points in the deployment. The controller then determines whether upstream and downstream traffic at one of the access points should be split. If the aggregate upstream traffic demand for that access point is large, the controller may instruct the access point and the mobile devices connected to the access point to shift downstream traffic to another, more distant access point. As a result, the access point continues to handle upstream traffic from the mobile devices, but the mobile devices begin receiving downstream traffic from another access point that is further away. In this manner, the network continues to handle both upstream and downstream traffic from the mobile devices.

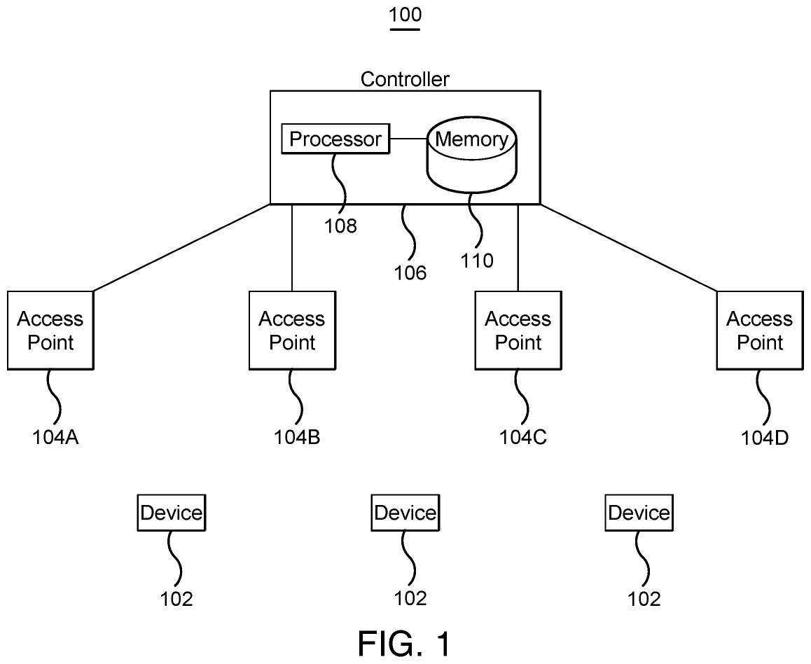

FIG. 1 illustrates an example system 100. As seen in FIG. 1, the system 100 includes one or more devices 102, one or more access points 104, and a controller 106. Generally, the controller 106 coordinates the upstream and downstream traffic between the devices 102 and the access points 104 so that the access points 104 do not become congested or overloaded. For example, the controller 106 may instruct some devices 102 to transmit upstream traffic to one access point 104 while receiving downstream traffic from another, more distant access point 104. In this manner, both the upstream and the downstream traffic may experience less delay through the system 100, which results in an improvement in network performance.

The devices 102 may wirelessly connect with one or more of the access points 104. Once connected, the devices 102 may transmit upstream traffic to the access points 104, and the devices 102 may receive downstream traffic from the access points 104. In some embodiments, the devices 102 include multiple radios that allow the devices 102 to form multiple connections to multiple access points 104 (which may be referred to as multi-link operation). For example, the devices 102 may form a first connection with an access point 104 for upstream traffic, and a second connection with another access point 104 for downstream traffic. The device 102 may form the first connection with an access point 104 that is physically closest to the device 102. The device 102 may communicate upstream traffic to the access point 104 using this first connection. The device 102 may form the second connection with another more distant access point 104. The device 102 may receive downstream traffic over the second connection.

The device 102 is any suitable device for communicating with components of the system 100. As an example and not by way of limitation, the device 102 may be a computer, a laptop, a wireless or cellular telephone, an electronic notebook, a personal digital assistant, a tablet, or any other device capable of receiving, processing, storing, or communicating information with other components of the system 100. The device 102 may be a wearable device such as a virtual reality or augmented reality headset, a smart watch, or smart glasses. The device 102 may also include a user interface, such as a display, a microphone, keypad, or other appropriate terminal equipment usable by the user. The device 102 may include a hardware processor, memory, or circuitry configured to perform any of the functions or actions of the device 102 described herein. For example, a software application designed using software code may be stored in the memory and executed by the processor to perform the functions of the device 102.

The system 100 includes one or more access points 104. In the example of FIG. 1, the system 100 includes the access points 104A, 104B, 104C, and 104D. Each of these access points 104A, 104B, 104C, and 104D may be installed at different locations. For example, each of the access points 104A, 104B, 104C, and 104D may be positioned in a different area of a large venue to provide network coverage to the different areas of the venue. Typically, as a device 102 moves throughout the venue, the device 102 connects to the access point 104 that is physically closest to the device 102. The device 102 then transmits upstream traffic and receives downstream traffic from that access point 104. When many devices 102 are in the same area and connect to the same access point 104, and when these devices 102 all begin to communicate a large amount of upstream traffic to that access point 104 (e.g., because the devices 102 are livestreaming or livecasting), the access point 104 may dedicate a significant portion of its resources to handling the upstream traffic. As a result, the access point 104 may not have sufficient resources available to handle downstream traffic. As a result, devices 102 connected to the access point 104 may experience delays receiving downstream traffic or transmitting additional upstream traffic to the access point 104.

The controller 106 coordinates the operation of the access points 104 in the system 100. For example, the controller 106 may coordinate the operations of the access points 104A, 104B, 104C, and 104D. As seen in FIG. 1, the controller 106 includes a processor 108 and a memory 110, which may perform the actions or functions of the controller 106 described herein.

The processor 108 is any electronic circuitry, including, but not limited to one or a combination of microprocessors, microcontrollers, application specific integrated circuits (ASIC), application specific instruction set processor (ASIP), and/or state machines, that communicatively couples to memory 110 and controls the operation of the controller 106. The processor 108 may be 8-bit, 16-bit, 32-bit, 64-bit or of any other suitable architecture. The processor 108 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 108 may include other hardware that operates software to control and process information. The processor 108 executes software stored on the memory 110 to perform any of the functions described herein. The processor 108 controls the operation and administration of the controller 106 by processing information (e.g., information received from the devices 102, access points 104, and memory 110). The processor 108 is not limited to a single processing device and may encompass multiple processing devices.

The memory 110 may store, either permanently or temporarily, data, operational software, or other information for the processor 108. The memory 110 may include any one or a combination of volatile or non-volatile local or remote devices suitable for storing information. For example, the memory 110 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 110, a disk, a CD, or a flash drive. In particular embodiments, the software may include an application executable by the processor 108 to perform one or more of the functions described herein.

The controller 106 monitors the traffic at the access points 104A, 104B, 104C, and 104D. For example, the controller 106 may observe the amount of upstream traffic and downstream traffic being handled by each of the access points 104A, 104B, 104C, and 104D. As another example, the controller 106 may monitor the buffer status reports received by the access points 104A, 104B, 104C, and 104D from the devices 102. These buffer status reports may indicate an amount of traffic awaiting transmission at each of the devices 102, which provides an indication of the future upstream traffic that the access points 104A, 104B, 104C, and 104D will be expected to handle. In certain embodiments, the controller 106 determines an aggregate upstream traffic demand for each of the access points 104A, 104B, 104C, and 104D using the observed upstream traffic handled by the access points 104A, 104B, 104C, and 104D and the upstream traffic awaiting transmission at the devices 102 indicated by the buffer status reports. If the aggregate upstream traffic demand for an access point (e.g., access point 104A) exceeds a threshold, the controller 106 may determine that the other access points (e.g., the access points 104B, 104C, and 104D) may assist in handling traffic. For example, the controller 106 may instruct one of the other access points to handle the downstream traffic for the access point.

As an example, if the controller 106 determines that the access point 104A is handling too much upstream traffic (e.g., due to livestreaming or livecasting), the controller 106 may coordinate the connections in the system 100 so that another access point 104B, 104C or 104D begins handling the downstream traffic for the access point 104A. The controller 106 may monitor the amount of upstream traffic being handled by the access point 104A, and the controller 106 may monitor the amount of upstream traffic awaiting at the devices 102 connected to the access point 104A by analyzing the buffer status reports from these devices 102. Using this information, the controller 106 determines an aggregate upstream traffic demand for the access point 104A. When the aggregate upstream traffic demand exceeds a threshold, the controller 106 may coordinate the connections in the system 100 so that the devices 102 connected to the access point 104A form another connection with another access point 104B, 104C, or 104D to handle the downstream traffic. As a result, the devices 102 have one connection with the access point 104A that handles the upstream traffic from the devices 102 and a second connection with another more, distant access point 104B, 104C, or 104D that handles the downstream traffic to the devices 102. In this manner, the controller 106 may ensure that the access point 104A has sufficient resources available to handle the traffic being sent to the access point 104A. Additionally, the controller 106 may ensure that sufficient resources are available to handle the downstream traffic to the devices 102.

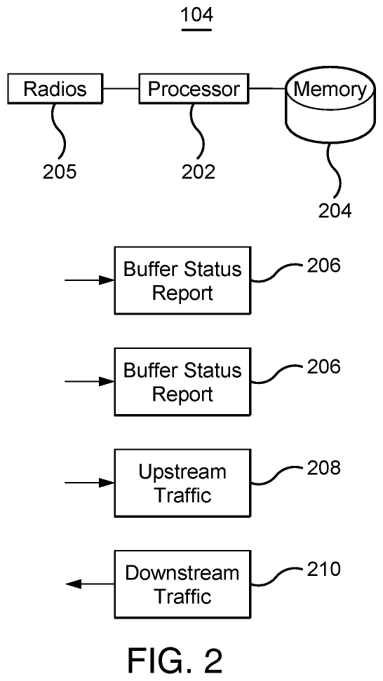

FIG. 2 illustrates an example access point 104 in the system 100 of FIG. 1. As seen in FIG. 2, the access point 104 includes a processor 202, a memory 204, and one or more radios 205. Generally, the processor 202, memory 204, and radios 205 are configured to perform the actions or functions of the access point 104 described herein.

The processor 202 is any electronic circuitry, including, but not limited to one or a combination of microprocessors, microcontrollers, application specific integrated circuits (ASIC), application specific instruction set processor (ASIP), and/or state machines, that communicatively couples to memory 204 and controls the operation of the access point 104. The processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 202 may include other hardware that operates software to control and process information. The processor 202 executes software stored on the memory 204 to perform any of the functions described herein. The processor 202 controls the operation and administration of the access point 104 by processing information (e.g., information received from the devices 102, controller 106, and memory 204). The processor 202 is not limited to a single processing device and may encompass multiple processing devices.

The memory 204 may store, either permanently or temporarily, data, operational software, or other information for the processor 202. The memory 204 may include any one or a combination of volatile or non-volatile local or remote devices suitable for storing information. For example, the memory 204 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 204, a disk, a CD, or a flash drive. In particular embodiments, the software may include an application executable by the processor 202 to perform one or more of the functions described herein.

The radios 205 may be used to wirelessly transmit information to or wirelessly receive information from other components in the system 100. For example, the access point 104 may use the radios 205 to form connections with the devices 102 or the controller 106. The access point 104 may also use the radios 205 to form connections with other access points 104. In some embodiments, the access point 104 uses the radios 205 to form wireless connections with the devices 102. After the connections are formed, the access point 104 may use the radios 205 to communicate downstream traffic to the connected devices 102 and to receive upstream traffic from the devices 102.

The access point 104 may receive buffer status reports 206 from the connected devices 102. The buffer status reports 206 may include information that indicates an amount of uplink traffic awaiting transmission at the devices 102. As a result, the buffer status reports 206 may indicate an amount of future upstream traffic for the access point 104 to handle. When the devices 102 release or transmit that upstream traffic to the access point 104, the access point 104 will be expected to handle that upstream traffic.

The access point 104 handles upstream traffic 208 from the devices 102 and communicates downstream traffic 210 to the devices 102. For example, the access point 104 may receive upstream traffic 208 from the connected devices 102 and then communicate that upstream traffic 208 towards their destination. The access point 104 may receive downstream traffic 210 from other components in the system 100 or from other networks and then communicate that downstream traffic 210 to the connected devices 102. When the devices 102 connected to the access point 104 begin livestreaming or livecasting, the amount of upstream traffic 208 handled by the access point 104 may begin to increase. The access point 104 may dedicate more of its resources to handling the upstream traffic 208. If no action is taken, the access point 104 may use so much of its resources to handle the upstream traffic 208 that the access point 104 no longer has sufficient resources to handle the downstream traffic 210. As a result, the connected devices 102 may experience delays receiving the downstream traffic 210.

In some embodiments, the controller 106 may coordinate the connections and communications in the system 100 so that another access point 104 helps the access point 104 by handling the downstream traffic 210 to the devices 102 for the access point 104. The other access point 104 may be more physically distant from the devices 102 than the access point 104. As a result, the access point 104 continues handling the upstream traffic 208 from the devices 102, and the other access point 104 handles the downstream traffic 210 to the devices 102. In certain embodiments, the access points 104 in the system 100 may implement beamforming features that help increase the range of the access points 104 when transmitting downstream traffic 210 to connected devices 102. As a result, using a more physically distant access point 104 to communicate the downstream traffic 210 to the devices 102 may not cause the devices 102 to experience substantial difficulty receiving the downstream traffic 210 from the more distant access point 104.

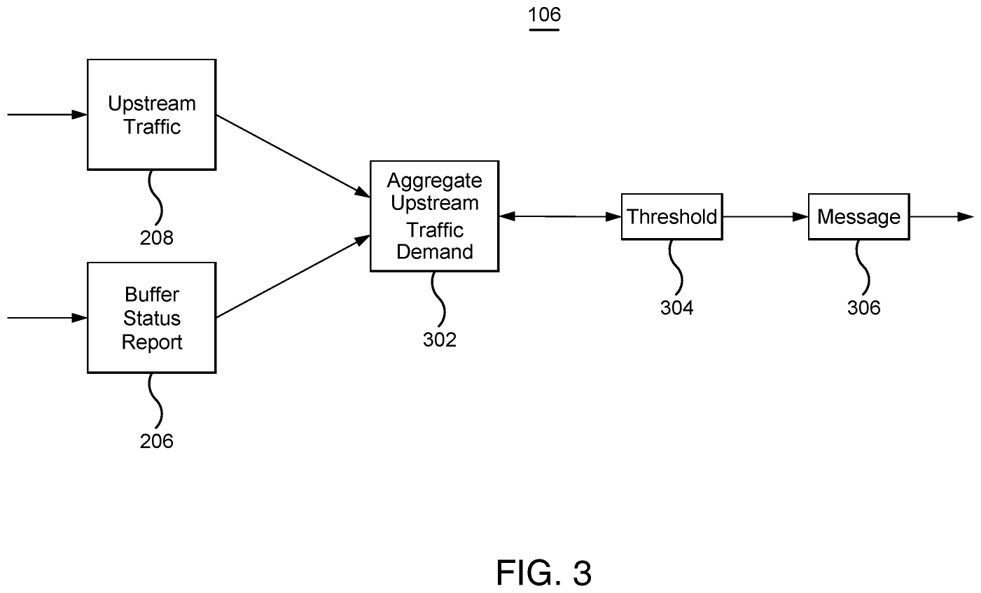

FIG. 3 illustrates an example controller 106 in the system 100 of FIG. 1. Generally, the controller 106 monitors the upstream traffic demand on an access point 104. When the upstream traffic demand at the access point 104 is too high, the controller 106 redirects the downstream traffic at the access point 104 to another access point 104 in the system 100.

The controller 106 monitors the upstream traffic 208 and the buffer status reports 206 at the access point 104. For example, the controller 106 may keep track of the amount of upstream traffic 208 being handled by the access point 104. Additionally, the controller 106 may analyze the buffer status reports 206 received at the access point 104 to determine an amount of future upstream traffic that the access point 104 will be expected to handle. Using this information, the controller 106 calculates an aggregate upstream traffic demand 302 on the access point 104.

In some embodiments, the controller 106 calculates the aggregate upstream traffic demand 302 by summing weighted products of the upstream traffic 208 and the future traffic indicated in the buffer status report 206 from each device 102 connected to the access point 104. For example, each device 102 connected to the access point 104 may send an amount of upstream traffic 208 (U) to the access point 104. Each device 102 may also send a buffer status report 206 to the access point 104 that indicates an amount of future upstream traffic (B) that the access point 104 will be expected to handle. Additionally, the controller 106 may also assign a coefficient (C) to the device 102 based on the type of upstream traffic sent by the device 102. The coefficient may relate to a quality of service (QOS) for the upstream traffic type. For example, upstream traffic types with a high QoS (e.g., video traffic or voice traffic) may be assigned a higher coefficient (C). The controller 106 calculates a traffic demand presented by each device 102 by multiplying the amount of upstream traffic 208 (U) with the amount of future upstream traffic (B) and the coefficient (C). The controller 106 then sums the traffic demand presented by every connected device 102 to determine the aggregate upstream traffic demand 302. The aggregate upstream traffic demand 302 may be expressed as the following:

$${\sum }_{i} {U}_{i} * {B}_{i} * {C}_{i}$$

where i indicates the i-th device 102 connected to the access point 104.

The controller 106 compares the aggregate upstream traffic demand 302 for the access point 104 to a threshold 304 to determine if the access point 104 has sufficient resources to handle both upstream traffic and downstream traffic. The threshold 304 may be set according to the needs of the network and the capabilities of the access point 104. Each of the access points 104 in the system 100 may have the same or different threshold 304. The controller 106 may adjust the threshold 304 depending on the needs of the network. For example, the threshold 304 may be adjusted depending on the number of devices 102 connected to the network and the number of available access points 104 in the network.

If the aggregate upstream traffic demand 302 exceeds the threshold 304, the controller 106 generates and communicates a message 306 to one or more access points 104 in the system 100. The message 306 may cause the downstream traffic at an access point 104 to be shifted to another access point 104 in the system 100. For example, if the aggregate upstream traffic demand 302 for the access point 104A exceeds the threshold 304, then the controller 106 may communicate the message 306 to the access point 104A. The message 306 may instruct the access point 104A to shift its downstream traffic to another access point 104B in the system 100. The controller 106 may communicate the message 306 or another message 306 to the access point 104B to instruct the access point 104B to handle the downstream traffic to the devices 102. The access point 104A may cause the devices 102 connected to the access point 104A to form another wireless connection with the access point 104B. These devices 102 may then transmit upstream traffic to the access point 104A and receive downstream traffic from the access point 104B. As a result, the access point 104A continues to handle the upstream traffic from the devices 102, and the downstream traffic, which the access point 104A may not have sufficient resources to handle, are instead handled by the access point 104B. As a result, the devices 102 may experience less delay when receiving the downstream traffic, in certain embodiments.

The access point 104A may cause the connected devices 102 to form a new connection with the access point 104B in any suitable manner. For example, when the access point 104A receives the message 306 from the controller 106, the access point 104A may instruct the connected devices 102 to disassociate from the access point 104A. In response, the devices 102 may disconnect from the access point 104A and connect to the next physically closest access point, which may be the access point 104B. The access point 104A or the access point 104B may then send these devices 102 beacons that tell the devices 102 that the access point 104B is not suitable or not available to handle upstream traffic from the devices 102 (e.g., that upstream traffic at the access point 104B is limited). In response, the devices 102 may form a second connection with the access point 104A to handle the upstream traffic. As a result, the devices 102 use the access point 104A for upstream traffic, and the access point 104B for downstream traffic. Additionally, because the access points 104A and 104B may use beamforming to communicate downstream traffic to the devices 102, using the access point 104B that is more physically distant from the devices 102 than the access point 104A to communicate downstream traffic to the devices 102 may not cause a significant degradation in the downstream traffic.

When the aggregate upstream traffic demand 302 of the access point 104A falls below the threshold 304 (e.g., because the devices 102 stop livestreaming or livecasting), the controller 106 may communicate another message 306 that causes the access points 104A and 104B to return to their original operations. For example, the devices 102 may disassociate from the access point 104B. The access point 104A may then handle both the upstream traffic and downstream traffic from the devices 102. As a result, the devices 102 transmit upstream traffic to the access point 104A and receive downstream traffic from the access point 104A.

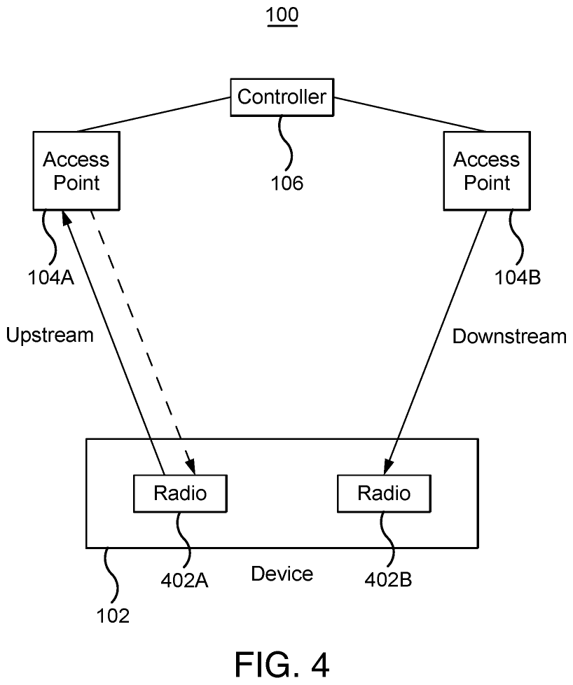

FIG. 4 illustrates an example of access point switching in the system 100 of FIG. 1. As seen in FIG. 4, the controller 106 coordinates the upstream and downstream traffic from a device 102 to the access points 104A and 104B. Generally, the controller 106 may communicate the message 306 (shown in FIG. 3) to one or more of the access points 104A and 104B to coordinate the upstream and downstream traffic.

The device 102 may include any suitable number of radios 402. In the example of FIG. 4, the device 102 includes the radios 402A and 402B. Initially, the device may have connected to the access point 104A using the radio 402A. Upstream traffic and downstream traffic are then communicated over this connection using the radio 402A. For example, the radio 402A may communicate upstream traffic to the access point 104A, and the radio 402A may receive downstream traffic from the access point 104A.

When the controller 106 determines that the aggregate upstream traffic demand 302 (shown in FIG. 3) of the access point 104A, exceeds the threshold 304 (shown in FIG. 3), the controller 106 may determine that the access point 104A should shift the downstream traffic at the access point 104A to the access point 104B. The controller 106 may communicate the message 306 to the access point 104A and the access point 104B to coordinate the shifting of the downstream traffic.

Generally, when the access points 104A and 104B receive the message 306 from the controller 106, the access points 104A and 104B may communicate instructions to the device 102 that cause the device 102 to form two separate connections. In the example of FIG. 4, the device 102 uses the radio 402A to form a first connection with the access point 104A and the radio 402B to form a second connection with the access point 104B. The device 102 then uses the radio 402A to communicate upstream traffic to the access point 104A and the radio 402B to receive downstream traffic from the access point 104B. The downstream traffic from the access point 104A (indicated by the dashed arrow) may be stopped or limited, and the bulk of the downstream traffic may be received from the access point 104B. The access point 104B is more physically distant from the device 102 than the access point 104A. The access point 104B may implement beamforming to transmit messages to the device 102, which may improve the signal quality over the connection between the access point 104B and the device 102. As a result, the device 102 may successfully communicate upstream traffic and successfully receive downstream traffic. The access point 104A, which may not have sufficient resources to handle both the upstream and downstream traffic is instead tasked with handling only the upstream traffic.

In some embodiments, the access point 104A may cause the device 102 to from a new connection with the access point 104B by first instructing the device 102 to disassociate from the access point 104A. The device 102 disconnects the radio 402A from the access point 104A and connects the radio 402B to the access point 104B. The access point 104A or the access point 104B then communicate another instruction (e.g., a beacon) that indicates that the access point 104B is not suitable or available to handle upstream traffic from the device 102. In response, the device 102 forms a connection with the access point 104A using the radio 402A. The device 102 then communicates upstream traffic to the access point 104A using the radio 402A and receives downstream traffic from the more distant access point 104B using the radio 402B.

In certain embodiments, the access point 104A selects one of the radios 402A or 402B (e.g., the radio 402A or 402B with lower modulation coding scheme (MCS) to the matching radio in the access point 104A) and triggers a roam to the farther access point 104B. This mechanism can take the form of a basic service set (BSS) transition management (BTM) (with disassociation imminent, and suggestion for an alternative access point with the farther access point 104B; other nearby access points may decline the device 102 association). This mechanism can also take the form of an access point extended service set (ESS) report indicating that the device's 102 weaker link is below the target received signal strength indicator (RSSI), and pointing again to the farther access point 104B as the next hop recommended access point. At the end of this process, one radio 402A is still associated to the closer access point 104A, while the second radio 402B is associated to the farther access point 104B.

The goal is then to let the device 102 send the bulk of its upstream traffic to the close access point 104A while receiving the bulk of the downstream traffic from the farther access point 104B. Several suitable processes are available to achieve this goal. In one embodiment, the farther access point 104B restricts the uplink (UL) transmission opportunity (TXOP) resource units (RUs) made available to the device 102, thus causing the device 102 to empty its upstream buffer faster on the closer access point 104A than on the farther access point 104B. In another embodiment, the farther access point 104B sends unsolicited probe responses to the device 102, indicating less favorable enhanced distributed channel access (EDCA) elements (e.g. longer arbitration inter-frame spacing numbers (AIFSNs), more restricted TXOPs parameters). In another embodiment, the farther access point 104B sends unsolicited “prove responses” to the device 102, indicating longer BSS average access delay and longer BSS access category access delay, thus causing the device 102 the prefer the closer access point 104 for upstream traffic. Such restricted advertisement may be selective (e.g. allowing access category background (AC_BK) upstream to the farther access point 104B while causing the other access categories to be sent to the closer access point 104A). Other methods are possible (e.g. delayed acknowledgement for frames, causing a slowdown of upstream traffic on the farther access point 104B).

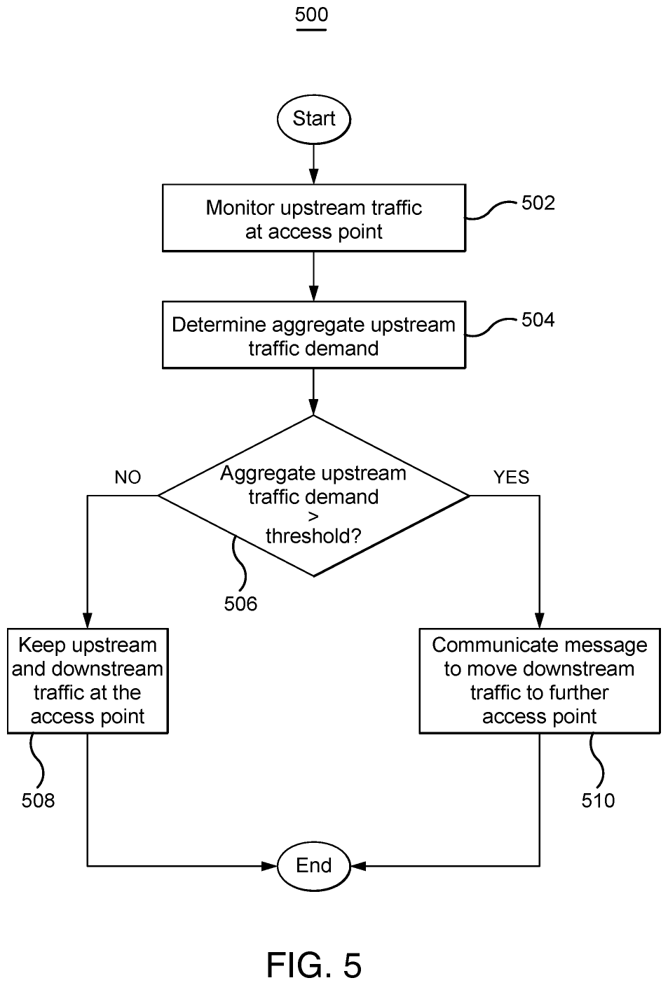

FIG. 5 is a flowchart of an example method 500 performed in the system 100 of FIG. 1. In particular embodiments, the controller 106 performs the method 500. By performing the method 500, the controller 106 shifts downstream traffic away from an access point 104A when there is too much upstream traffic at the access point 104A.

In block 502, the controller 106 monitors the upstream traffic 208 at the access point 104A. For example, the controller 106 may determine an amount of current upstream traffic that the access point 104 is handling. Additionally, the controller 106 may analyze the buffer status reports 206 received at the access point 104A to determine an amount of future upstream traffic that the access point 104A will be expected to handle.

In block 504, the controller 106 determines an aggregate upstream traffic demand 302 for the access point 104A. In some embodiments, the controller 106 determines the aggregate upstream traffic demand 302 by summing the weighted products of the upstream traffic 208 being handled by the access point 104A and the amount of future traffic indicated by the buffer status reports 206. For each connected device 102, the controller 106 may determine a weighted product of the upstream traffic from that device 102 that the controller 106 is handling and the future upstream traffic awaiting at the device 102. The weight may be a coefficient related to the QoS for the upstream traffic (e.g., higher QoS results in a higher coefficient). The controller 106 may then sum the weighted products of the connected devices to determine the aggregate upstream traffic demand 302 for the access point 104A.

In block 506, the controller 106 determines whether the aggregate upstream traffic demand 302 for the access point 104A exceeds the threshold 304. The threshold 304 may be set according to the needs of the network and the resources in the access point 104A. The controller 106 may adjust the threshold 304 as conditions in the network or in the access point 104A change. If the aggregate upstream traffic demand 302 for the access point 104A does not exceed the threshold 304, then the controller 106 may determine that the access point 104A has sufficient resources to handle both the upstream and the downstream traffic at the access point 104A. In response, the controller 106 keeps both the upstream and downstream traffic at the access point 104A in block 508.

If the aggregate upstream traffic demand 302 at the access point 104A exceeds the threshold 304, the controller 106 may determine that the access point 104A does not have sufficient resources to handle both the upstream traffic and the downstream traffic. In block 510 the controller 106 communicates the message 306 to move the downstream traffic to another access point 104B. The access point 104B may be more physically distant from the device 102 than the access point 104A. In response, the device 102 forms a new connection with the access point 104B to receive the downstream traffic from the access point 104B. The device 102 continues to transmit upstream traffic to the access point 104A. The device 102 may use different radios 402A and 402B to support these two different connections. As a result, the access point 104A continues to handle the upstream traffic while the access point 104B begins handling the downstream traffic.

In summary, a system 100 coordinates the upstream and downstream traffic in a network deployment. Specifically, the system 100 includes a controller 106 that determines an aggregate upstream traffic demand 302 for the access points 104 in the deployment. The controller then determines whether upstream and downstream traffic at one of the access points 104A should be split. If the aggregate upstream traffic demand 302 for that access point 104A is large, the controller 106 may instruct the access point 104A and the devices 102 connected to the access point 104A to shift downstream traffic to another, more distant access point 104B. As a result, the access point 104A continues to handle upstream traffic from the device 102, but the devices 102 begin receiving downstream traffic from another access point 104B that is further away. In this manner, the network continues to handle both upstream and downstream traffic from the devices 102.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
monitoring an upstream traffic demand at a first access point; and
based at least in part on the upstream traffic demand on the first access point, communicating a message that causes a mobile device to transmit upstream messages to the first access point and to receive downstream messages from a second access point, wherein the first access point is physically closer to the mobile device than the second access point.

2. The method of claim 1, wherein the message causes the mobile device to associate a first radio of the mobile device with the first access point to transmit the upstream messages and to associate a second radio of the mobile device with the second access point to receive the downstream messages.

3. The method of claim 2, wherein the message causes the mobile device to disassociate from the first access point.

4. The method of claim 1, wherein the message causes the second access point to limit a number of uplink transmission opportunities for the mobile device.

5. The method of claim 1, wherein the message causes the second access point to indicate to the mobile device that upstream traffic at the second access point is limited.

6. The method of claim 1, wherein the upstream traffic demand on the first access point is based on a buffer status report from the mobile device.

7. The method of claim 6, wherein the upstream traffic demand on the first access point is further based on a weight based on a traffic type.

8. The method of claim 1, further comprising calculating an aggregate upstream traffic demand based at least in part on the upstream traffic demand at the first access point, wherein the message is communicated in response to determining that the aggregate upstream traffic demand exceeds a threshold.

9. The method of claim 8, further comprising, in response to determining that the aggregate upstream traffic demand falls below the threshold, communicating a message that causes the mobile device to transmit upstream messages to the first access point and to receive downstream messages from the first access point.

10. An apparatus comprising:
a memory; and
a processor communicatively coupled to the memory, the processor configured to:
monitor an upstream traffic demand at a first access point; and
based at least in part on the upstream traffic demand on the first access point, communicate a message that causes a mobile device to transmit upstream messages to the first access point and to receive downstream messages from a second access point, wherein the first access point is physically closer to the mobile device than the second access point.

11. The apparatus of claim 10, wherein the message causes the mobile device to associate a first radio of the mobile device with the first access point to transmit the upstream messages and to associate a second radio of the mobile device with the second access point to receive the downstream messages.

12. The apparatus of claim 11, wherein the message causes the mobile device to disassociate the second radio from the first access point.

13. The apparatus of claim 10, wherein the message causes the second access point to limit a number of uplink transmission opportunities for the mobile device.

14. The apparatus of claim 10, wherein the message causes the second access point to indicate to the mobile device that upstream traffic at the second access point is limited.

15. The apparatus of claim 10, wherein the upstream traffic demand on the first access point is based on a buffer status report from the mobile device.

16. The apparatus of claim 15, wherein the upstream traffic demand on the first access point is further based on a weight based on a traffic type.

17. The apparatus of claim 10, wherein the processor is further configured to calculate an aggregate upstream traffic demand based at least in part on the upstream traffic demand at the first access point, wherein the message is communicated in response to determining that the aggregate upstream traffic demand exceeds a threshold.

18. The apparatus of claim 17, wherein the processor is further configured to, in response to determining that the aggregate upstream traffic demand falls below the threshold, communicate a message that causes the mobile device to transmit upstream messages to the first access point and to receive downstream messages from the first access point.

19. A non-transitory computer readable medium storing instructions that, when executed by a processor, cause the processor to:
determine an upstream traffic demand at a first access point positioned a first distance from a mobile device;
compare the upstream traffic demand to a threshold; and
in response to determining that the upstream traffic demand exceeds the threshold, communicate a message that causes the mobile device to transmit upstream messages to the first access point and to receive downstream messages from a second access point positioned a second distance from the mobile device, wherein the first distance is shorter than the second distance.

20. The medium of claim 19, wherein the mobile device comprises a first radio and a second radio, and wherein the message causes the mobile device to associate the first radio with the first access point to transmit the upstream messages and to associate the second radio with the second access point to receive the downstream messages.
